(19) United States
(12) Patent Application Publication
(10) Pub. No.: US 2025/0043632 A1
(43) Pub. Date: Feb. 6, 2025

(54) LADDER COMPRISING AT LEAST ONE RAIL AND A PLURALITY OF RUNGS

(71) Applicant: Amine El Boudali Aissa ZINAI, Bellevue (CH)

(72) Inventor: Amine El Boudali Aissa ZINAI, Bellevue (CH)

(21) Appl. No.: 18/717,251

(22) PCT Filed: Dec. 8, 2022
(86) PCT No.: PCT/EP2022/084988

§ 371 Date: Jun. 6, 2024

(30) Foreign Application Priority Data
Dec. 10, 2021 (EP) 21213839.0

(51) Int. Cl. E06C 7/08; E06C 1/06; E06C 1/20; E06C 1/38

(52) U.S. Cl. CPC E06C 7/08; E06C 1/06; E06C 1/20; E06C 1/381; E06C 7/082

(57) ABSTRACT

The present invention relates to a ladder (10) comprising at least one rail (11) and a plurality of rungs (12) integral with said at least one rail (11). Said ladder is characterised in that said at least one rail (11) comprises at least two stiffening members (14) arranged to receive a filler material, said at least one rail (11) being rigid when the stiffening members (14) contain said filler material and the rail (11) being flexible when the stiffening members (14) do not contain said filler material.

### TECHNICAL FIELD

The present invention relates to the field of ladders. More specifically, it relates to a ladder comprising at least one rail and a plurality of rungs integral with said at least one rail.

### PRIOR ART

Nowadays, there are ladders with so-called “flexible rails” or “rope ladders”, which have the practical advantage of being able to be folded or rolled up when not in use. In this way, they take up little space and are easy to store and transport, unlike conventional ladders with so-called “rigid rails”.

However, these ladders with flexible rails do have drawbacks. When a person has to climb to a great height using the rungs, these ladders can be dangerous. They lack rigidity and stability. This remains the case even when they are connected to fixed points, on their sides along their rails or by the rungs, suspended at the top and attached to fixed points by their base. They always tend to sway or twist as soon as they are subjected to a moving load.

The reason why ladders with flexible rails are unstable is that the side rails lack rigidity. When in use, these ladders are subjected to multiple twisting, bending and compression movements. They can quickly go into resonance when subjected to periodic or non-linear dynamic loads.

A person climbing this type of ladder can himself create dangerous disturbances simply by pushing his feet onto the rungs.

If the attachment points are themselves in motion, as in the case of a moving support such as a boat, the whole ladder is in motion. These movements add to and combine with those of the user, amplifying them.

These instabilities are often observed at sea, when ladders with flexible rails are used to allow a crew member to climb to the top of a sailboat's mast to carry out repairs in stormy weather or strong winds. This can also happen when such a ladder is hoisted to a tree branch and the latter is subject to movements caused by the action of the wind on the supporting branches.

These stresses cause oscillations, the amplitudes of which can become increasingly pronounced. This leads to instability. The amplitude can cause the climber to fall, leading to accidents with very serious consequences, especially when the fall occurs from great heights.

Another disadvantage of ladders with flexible rails is that the top of the ladder has to be attached before it can be used. This poses a problem if the place where the top of the ladder is to be hung is not accessible. Typically, when a ladder with flexible rails is to be used on a tree or boat mast, for example, it may be difficult or impossible to reach a hanging point and such a ladder cannot be used. It can also happen that the pulleys or their sheaves located at the masthead of a sailboat are worn or seized, which presents a danger at the high anchorage point of a ladder.

Of course, there are also ladders with rigid rails, which eliminate or at least minimise most of the disadvantages mentioned above. In particular, their stability is much better than that of ladders with flexible rails, and stresses generally cause little swaying movement. In addition, they can be used even if the top of the ladder is not accessible and do not require an anchoring point.

Their main disadvantage is that they take up a lot of space, making them cumbersome to store and transport.

It is therefore interesting to find a solution for making a ladder that combines the advantages of both types of ladders, i.e. the small footprint of ladders with flexible rails and the stability of ladders with rigid rails.

US patent application US 2019/0203533 describes an inflatable ladder comprising two side rails connected by a plurality of transverse rungs. Both the side rails and the rungs are made of an airtight material and define an airtight interior space. This inner space can be filled with air to stiffen the rails and rungs.

In this design, the rungs are not very rigid and there is a risk that the weight of a user on a rung of the ladder cause the rung to deform and the vertical rails to move closer together. The ladder would be difficult to use and only for relatively low heights.

Furthermore, it would be difficult to replace the inflatable rungs with rigid rungs due to the very construction of this ladder.

### DESCRIPTION OF THE INVENTION

The present invention relates to a ladder whose rails are flexible when it is not being used to reach an elevated location, i.e. during storage or transportation, and whose rails are rigid when it is being used to reach an elevated location.

The object of the invention is achieved by a ladder as defined in the preamble and characterised in that said at least one rail comprises at least two stiffening members arranged to receive a filler material, said at least one rail being rigid when the stiffening members contain said filler material and the rail being flexible when the stiffening members do not contain said filler material.

The invention consists of stiffening the rails of a ladder with flexible rails, such as a rope, cable, webbing or chain ladder, by surrounding these flexible rails with pockets or stiffening members that can be filled to make them rigid and emptied to make them flexible. These pockets or stiffening members are generally elongated. These stiffening members are generally filled with a fluid such as air, a gas, a mixture of gases or a liquid such as water. These stiffening members could also be filled with a granular material such as sand or balls.

According to a variant, the ladder of the invention can do without ropes, cables, webbing or chains, the side rails being formed solely by the stiffening members. In this case, the stiffening members themselves allow the ladder to be suspended and ensure the structural cohesion of the assembly. In this way, when the ladder is suspended, tensile stresses are correctly absorbed by the stiffening members, as are the mechanical stresses associated with the forces undergone.

Several stiffening members are preferably used to form each of the ladder rails. These stiffening members are arranged longitudinally parallel to each other like stair stringers, to form the ladder rails.

These ladder rails can have a circular, oval, rectangular, triangular or square cross section or can be made of a combination of shapes. The final shape of the cross-section depends on the intended use of the ladder and/or an aesthetic choice.

A ladder generally comprises two rails connected by rungs. Depending on its end use, it may have more than two rails, for example three or four, or on the contrary, just one rail.

The stiffening members have a peripheral envelope which may be coated or made partly or wholly of synthetic or natural materials. This peripheral envelope can be made up of a single layer or several superimposed, glued, sprayed, entangled, woven or braided layers. Different compositions of materials can be mixed together depending on the end use of the ladder.

The rails can also be made in whole or in part from commercially available inflatable woven materials, such as multi-layer fabric whose inner layers are connected by filaments, known as “Drop Stitch”.

The use of “drop-stitch” makes it easy to obtain rectangular sections of rails. The addition of several layers of “Drop Stitch” makes it possible to obtain sections with variable geometric shapes. Moreover, when the length of the drop stitch filaments is variable, the width of the rails can be varied, resulting in different rails cross-sections.

The stiffening members can be manufactured from compact or cellular materials to meet the functional requirements. They can be made of natural materials such as rubber, or synthetic materials such as elastomers, plastics, fibres/EPDM, Nitrile, PTFE, VITON, PVC, Silicone, PU, Chlorosulphonated Polyethylene (CSM Hypalon) or any other material with suitable physical characteristics.

Concerning the stiffening members, they are filled with a filler material such as air, gas or liquids. These fluids can be compressed to stiffen the assembly. They can also be filled with granular material such as sand or balls.

The filler materials are introduced into the body of the stiffening members via suitable valves. In the case of air, the stiffening members are inflated to an average pressure of between 0.2 and 1.4 bar. It should be noted that the pressure of the stiffening members may exceed these values depending on the desired end use of the ladder. The aim is to obtain the most suitable overall rigidity possible, in relation to the mechanical, physical and chemical characteristics of its components and to the use of the ladder. However, it is the overall equation, which takes into account the pressure factor, the very nature of the structure, the materials used and the end use of the ladder, which ensures the perfect rigidity of the rails and therefore of the ladders with inflatable rails.

Depending on the purpose of the ladder, it is possible to adapt the pressure of the fluid in the rails. For example, roof walking ladders are designed to be suspended from the ridge of roofs and lie on the tiles to enable tradesmen to work on the roof without damaging the tiles or purlins. In this case, the stiffening members are not inflated to high pressure, to prevent the surface of the rails in contact with the tiles from being too hard and damaging them or the roof. In this case, the stiffening members in direct contact with the roof are inflated at low pressure in order to maintain a certain softness, thus increasing the contact surface between the tiles and the rails and consequently reducing the pressure on the tiles.

In order to achieve high levels of pressure without risking damage to the stiffening members, herniation or bursting of the stiffening members when breaking pressures are exceeded, it is possible to provide a reinforcing structure that contributes to the good resistance of the stiffening members to bursting under the effect of excessive pressure. Such an excessive pressure can occur as a result of external phenomena such as variations in temperature or atmospheric pressure, leading to expansion of the fluids present in the stiffening members.

This consolidation structure can be formed by a tangle or regular mesh of wires, ropes, woven or non-woven materials, rigid materials or single or multiple membranes. The elements forming the consolidation structure can be knotted, glued or completely integrated into the stiffening members. For the same purpose, it is also possible to provide structural ligaments formed, for example, of wires that can be positioned between the different layers of the stiffening members or inside the stiffening member itself. These structural ligaments form a network inside these stiffening members. These ligaments can be arranged in such a way that they pass through in a “spider's web” fashion. They can be attached or knotted to the inner walls of the stiffening members at an angle of less than, equal to or greater than 90 degrees. The structural ligaments can be made of natural materials such as rubber, or synthetic materials such as elastomers, plastics, fibres, EPDM, Nitrile, PTFE, VITON, PVC, Silicone, PU or any other materials with similar physical characteristics.

This stiffens the stiffening members, making them resistant to cross-sectional deformation and powerful tensile forces, thanks to the mechanical distribution of stresses and the risk of “herniations” appearing on the surface of the stiffening members.

The ladder of the invention may also comprise a stiffening structure. Depending on the intended use of the ladder, the rigidity obtained by inflating the rails under high pressure may not be sufficient. It may be advisable to provide a stiffening structure. This stiffening structure may be made of ropes, wires, woven material, rigid material or any other suitable material. It may comprise one or more single or multiple membranes. This structure provides additional shape retention and cohesion of the ladder. This cohesion of shape comes from an entanglement or regular meshing of the stiffening elements which distribute the forces on the walls of the stiffening members.

The stiffening structure can be located on the circumference of certain stiffening members, between the stiffening members, between the rails or between the rails and the rungs.

In order to increase the rigidity of the rails, the stiffening structure comprises ropes, textile parts or membranes parallel to the rungs or crossed in the rear plane of the ladder between the rails. This assembly of ropes or textile parts prevents part of the stiffening members or rails from deforming when a force is exerted on the ladder, regardless of the direction of this force.

Once the stiffening members are inflated, the stiffening structure considerably reduces deformations, in particular:
1. resulting from excessive bending along the length of the inflated stiffening members when they are subjected to forces in directions parallel, perpendicular or antagonistic to their axis.
2. resulting from excessive compression of the stiffening members when they are subjected to forces parallel to the central axis of the stiffening members. This results in a variation in length, however slight, and therefore in longitudinal crushing (collapse), and sometimes even in the appearance of a secondary deformation of the bending type, when a ‘moment’ appears, in the case where there is a lever arm between the axis of the compression force and the central axis of the stiffening member.
3. resulting from the twisting of the stiffening members around their central axis, of all the rails or of the ladder as a whole.

The network of wires, ropes or fabric diaphragms limits unwanted deformation and, above all, dangerous deformation of the stiffening members and therefore the ladder rails. These stiffening elements give the whole ladder a level of overall rigidity that is reassuring.

The density, number and cross-section of wires in the stiffening structure, membranes, ropes and pieces of fabric or flexible materials vary according to the constraints imposed by the final shape of the ladder, the purpose of the ladder, the conditions of use and environmental factors.

Several ladders with inflatable rails can be assembled to create a stable fixed or mobile structure.

By way of example, it is possible to create a structure comprising three or four rails connected together by rungs, this structure delimiting an enclosed space. Such an enclosed space can be used to improve user safety. It can also be used to pass through a textile tube acting as an “escape chute”. Such an escape chute has an opening at the top of the ladder and another opening at the bottom. A ladder equipped in this way may have one or more escape chutes. Where several escape chutes are used, they may be arranged at the same or different heights.

The addition of such escape chutes means that ladders with inflatable rails can be used for rapid evacuation operations, for example from several floors of a building.

The rungs can be rigid, in one or more pieces, or made up of telescopic elements. They can be flexible, made of rope, webbing, fabric, semi-rigid materials or inflatable elements, depending on the end use of the ladder. They can be made from the same material as the rails. They can contribute to the structural rigidity of the ladder.

To limit undesirable movement and deformation of the ladder, it can be fixed to a fixed support during use. Hanging devices, such as hooks, as well as rope, wire or cable ties can be provided.

These devices ensure the stability of the ladder when it is subjected to static or dynamic loads. Above all, they prevent displacement in the event of resonance phenomena occurring in the structure. The ladder can, for example, be fixed along the shrouds of sailing boat rigging, to rails fixed, for example, to a mast, or to hooks inserted into the walls or facades of buildings, or to the roof rafters. Depending on the intended end use of the ladder, these and other fixing devices enable it to comply with safety standards, such as certain requirements of standard EN131.

To make it easier for an operator to inflate the ladder close to where it is installed, one or more filling valves are provided. On the other hand, so that the ladder can be easily deflated without any residual fluid at the end of use and easily rolled up for storage, a device is provided which prevents the fluid trapped inside the stiffening members from creating residual pockets. To achieve this, the stiffening members contain a network of non-compressible tubes, enabling air or gas to be routed to a fluid discharge valve when the ladder is deflated and rolled up.

In a similar way, the stiffening members can be equipped with a network of tubes to accelerate their inflation. The tubes in this network of tubes are inflated or filled with filler material as a priority, for example using gas cartridges, manual or electric pumps or any other suitable means. Inflating these tubes, which have a smaller volume than the total volume of the stiffening members, shapes the stiffening members, which automatically draw air from the outside through the inflation valves by means of a simple vacuum. This allows the stiffening members to be filled quickly with air by “automatic pre-inflation”, reducing the effort and time required for inflation. The inflation pressure required to obtain the desired rigidity of the rails can then be achieved by completing the inflation of the stiffening members using suitable pumps.

The stiffening members of the rails allow the passage of a network of wires, ropes, cables or yokes inside the body of the stiffening member or the body of the rail. These elements are designed to create variations in the shape of the stiffening members when the cables or ropes are put under tension.

These variations in shape, which are similar to “prestressing”, are used to create permanent deformations. These deformations can vary over time, allowing the object to be permanently adapted to mechanical, thermal or other stresses. In this way, the cables can be used to animate and modify the shapes of the stiffening members.

The stiffening members are dimensioned in such a way that they also allow electrical cables or sheaths to pass through them, to position motors and electronic components, lighting systems, systems for transferring or generating temperature variations, waves to be transferred, fluids or solids to be transported, depending on the structure's intended use.

### BRIEF DESCRIPTION OF THE DRAWINGS

The present invention and its advantages will be better understood with reference to the enclosed figures and the detailed description of a particular embodiment, in which:

FIG. 1 is a front view of a ladder according to the present invention, in a first embodiment;

FIG. 2 is a cross-sectional view of the ladder of FIG. 1;

FIG. 3 is a cross-sectional view of a ladder according to the invention, in a second embodiment;

FIG. 4 is a view of a detail of the end of a ladder of the invention according to a particular embodiment;

FIG. 5 is a cross-sectional view, similar to FIG. 3, of another embodiment of the invention;

FIG. 6 is a sectional view similar to FIG. 5, showing structural ligaments and a rung fastener;

FIG. 7 illustrates a detail of a stiffening member of a rail from FIG. 6;

FIG. 8 shows a variant of a design similar to that shown in FIG. 6;

FIG. 9 shows a variant of the ladder of the invention in which the ladder has a single rail;

FIG. 10 is a cross-sectional view of the ladder shown in FIG. 9;

FIG. 11 shows a detail of a rail of a ladder according to the invention, illustrating a consolidation structure;

FIG. 12 shows another detail of the rails of a ladder according to the invention, illustrating a stiffening structure;

FIG. 13 is a side view of a particular embodiment of the invention;

FIG. 14 is a front view of an alternative embodiment of the invention, illustrating the ladder fastening elements; and

FIG. 15 shows a detail of the fastening elements for the ladder in FIG. 14.

### EMBODIMENT OF THE INVENTION

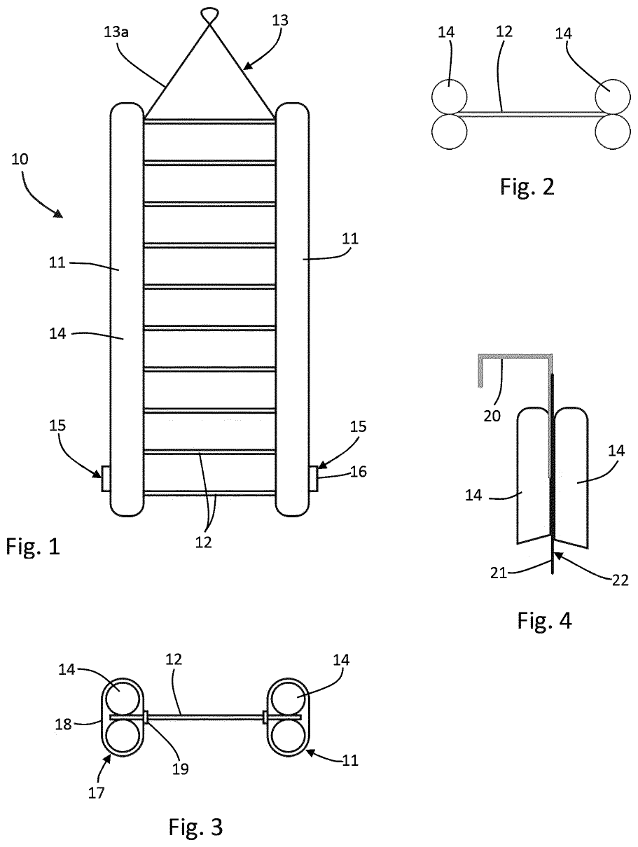

With particular reference to FIGS. 1 and 2, the ladder 10 according to the invention comprises two rails 11 arranged parallel to each other and a plurality of rungs 12, the ends of which are integral with the rails. The ladder 10 also comprises a hanging device 13 designed to attach the top of the ladder or an area near the top of the ladder to a support.

Each of the rails 11 is formed by stiffening members 14 made of a flexible material, each of which can be filled with a filler material to make it rigid. The filler material can also be extracted from the stiffening member 14 so as to empty the stiffening member and restore its flexibility. The filler material may be a gas, a mixture of gases such as air, or a liquid such as water. The filler material could also be a granular material such as sand or balls. The stiffening members are preferably sealed against the filler material.

In the context of the invention, a stiffening member is considered to be filled when its rigidity is sufficient for the desired application. This rigidity may be different depending on whether the ladder is leaning against a support, suspended by its top or resting on a support such as a roof. A stiffening member is considered empty when it can be folded or rolled on itself.

The stiffening members also comprises a device for introducing 15 the filler material. This introduction device is preferably a valve 16 which can be connected to a source of filler material so as to allow the filler material to be introduced into the stiffening member 14.

Depending on the design, the stiffening members 14 may have several introduction devices 15, for example to enable faster filling or to enable different zones of the stiffening members to be filled.

In a specific embodiment, the rungs 12 are made of a rigid material such as a metal cylinder. These rungs are fixed to the rails 11 by a suitable fixing system. By way of example, the rungs 12 could be fixed to a plate of thick fabric, itself fixed to one of the rails by means of rivets or by gluing. Clearly, other ways of attaching the rungs to the rails are possible.

The hanging device 13 may comprise a rope 13a having one end attached to one end of one of the rails and another end attached to the corresponding end of the other rail. This rope 13a may comprise a loop in its middle, this loop being used to secure the ladder to an anchoring point.

When the ladder 10 is to be used, it can be unfolded, possibly by fixing the hanging device 13 to an anchoring point. This attachment can be moved, for example, by means of a rope on a pulley if the ladder is used on a boat or a building, or by a rope passing over a branch if the ladder is used along a tree.

The filler material is then introduced into the stiffening members 14. For example, if the filler material is air or water, a pump can be provided to inject the air or water into the stiffening members 14 via valves 16 of the introduction device 15. The filler material is introduced until the rails 11 reach a certain rigidity, then the valves 16 are closed to prevent the filler material escaping from the stiffening members. The ladder can then be used and has a much-improved rigidity compared to known flexible rail ladders. Of course, rigidity can be further improved by securing the rails in stable locations. For example, the rails can be fixed to the ground or to different anchor points at different points on the ladder.

When the ladder 10 can be put away after use, the valves 16 can be opened to allow the filler material to escape. It is also possible to provide a pump for emptying more completely the stiffening members forming the rails. It is also possible to provide reinforcement zones or tubes (not shown) inside the stiffening members, arranged so as to avoid the formation of pockets of residual material inside the stiffening members, when these stiffening members are emptied.

The top of the ladder can be detached from its anchorage point before or after emptying the stiffening members, depending on the use of the ladder, and the rails can be folded or rolled.

The tubes can also be used as “pre-filling” elements. In fact, these tubes can be inflated or filled with filler material as a priority, which has the effect of unwinding or shaping the rails. Priority filler of these tubes is interesting because, due to the reduced volume of the tubes compared to the stiffening members, they can be filled relatively quickly. Shaping the rails creates a vacuum in the stiffening members, which automatically pre-fills the stiffening members. They are then filled in the conventional way until the desired rigidity or pressure is achieved.

In the embodiment shown in FIGS. 3 and 4, each rail 11 comprises two stiffening members 14. These rails comprise a consolidation structure 17 formed by an envelope 18 surrounding the two stiffening members 14 so as to hold them together. The purpose of this envelope 18 is, on the one hand, to hold the stiffening members 14 together and, on the other hand, to protect them against mechanical attack, damage or other factors. In the embodiment illustrated, the rungs 12 are held in place by holding elements 19 such as metal, leather or thick fabric plates, fixed to the envelope 18. Alternatively, they could be clamped between the stiffening members of the rails and fixed to the envelope 18.

According to a variant illustrated by FIG. 4, the upper ends of the rails 11 may each comprise a rigid hook 20. These hooks can be used to suspend the ladder from a support, in the manner of a so-called “hook ladder”.

When the rails 11 are filled and rigid, the ladder can be moved by manipulating it by its base so as to attach the hooks 20 to a rigid support.

When the stiffening members 14 are empty, i.e. contain little or no filler material, the rails 11 are flexible and can be folded or rolled to take up relatively little space.

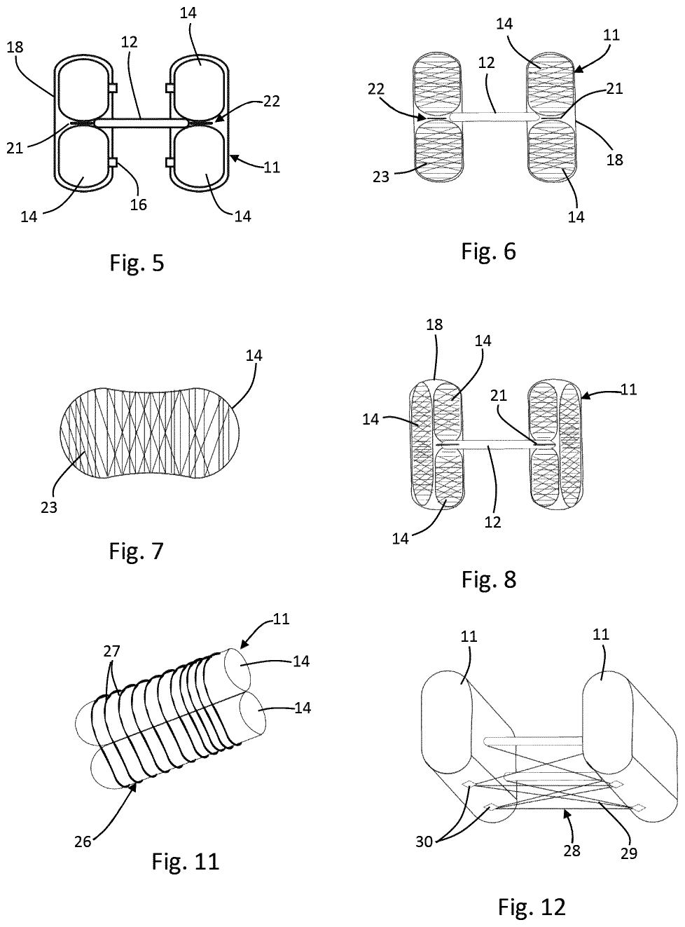

In the embodiment illustrated in FIG. 5, each of the rails 11 also has two stiffening members 14. A strap 21 is arranged between the two stiffening members 14 of the same rail 11. This strap 21 forms a fastening member 22 for the rungs. The rungs 12 of the ladder are integral with the straps arranged in the two rails, between the stiffening members.

The advantage of this design is that the rungs 12 are attached to the strap 21 and not to the stiffening members 14. The stiffening members therefore do not include any elements which could reduce their strength or form weakening zones. In addition, these stiffening members 14 can be protected against mechanical damage by means of the envelope 18.

The fastening member 22 for the rungs may comprise a strap, rope, cable or chain.

The stiffening members 14 of a same rail 11 can each have one or more valves 16 for introducing the filler material. They can also communicate with each other so that the filler material introduced into one of the stiffening members passes into another stiffening member.

In the embodiment illustrated in FIG. 6, each rail 11 also has two stiffening members 14. These stiffening members are made from a “drop-stich” type material, giving them a substantially rectangular cross-sectional shape. Such a shape may be desired for aesthetic reasons and/or depending on the purpose of the ladder. Structural ligaments 23 are formed inside the stiffening members 14 to prevent deformation or herniation and to promote uniform distribution of forces. These stiffening members may or may not be surrounded by an envelope 18 as described with reference to FIGS. 3 and 5.

FIG. 7 illustrates in detail the structural ligaments 23 formed inside a stiffening member 14 as shown in FIG. 6.

In the embodiment shown in FIG. 8, each rail 11 has three stiffening members 14. Two of these are similar to those shown in FIG. 6 and surround a strap 21 to which the rungs 12 are attached. The third stiffening member 14 is located on the outside of the ladder. This third stiffening member has a width corresponding to the total width of the other two stiffening members. The three stiffening members 14 are surrounded by a casing 18.

This configuration increases the rigidity of the ladder as a whole when the stiffening members are filled. The third stiffening member also covers the ends of the rungs 12, preventing a user from injuring themselves against these ends.

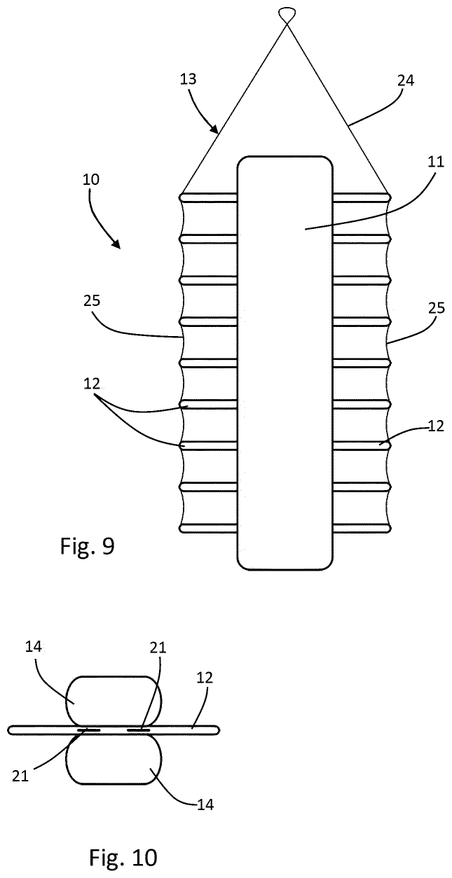

FIGS. 9 and 10 illustrate an example in which the ladder 10 has a single rail 11. This rail 11 may comprise two stiffening members 14, which are held together by an envelope (not shown). In the example shown, the rail 11 has two ropes or straps 21 of a rung fastener, to which these rungs 12 are attached. This increases the rigidity of the ladder and prevents the rungs from moving out of their position substantially perpendicular to the rails when a user climbs onto them.

The rail and/or one or more rungs can also be fitted with an attachment rope 24 of a hanging device 13 or hooks for securing the ladder to an anchorage point.

It is also possible to have the ends of the rungs connected to each other by means of a stabilising rope 25 or a strap, so as to prevent the rungs 12 from tilting as much as possible when the ladder is in use.

FIG. 11 illustrates a detail of a rail 11 according to a particular embodiment of the ladder of the invention. In this embodiment, a rail comprises two stiffening members 14. These rails are held together by a consolidation structure 26. This can be realised by means of consolidation cords 27 wound helically around the stiffening members 14, for example. These consolidation cords 27 can be fixed irremovably to some of the stiffening members or to certain locations on one or both of the stiffening members, so as to prevent them from falling when the stiffening members are emptied. The consolidation structure 26 could comprise a net or straps arranged around the stiffening members.

In one variant, more than two stiffening members 14, for example three or four, can be used to form each of the ladder rails 11.

It is also possible to combine the consolidation structure 26 with an envelope 18. The consolidation structure 26 may have the function of holding the stiffening members together and preventing them from deforming, for example in the event of overpressure in these stiffening members. The envelope 18 may also have the function of holding the stiffening members 14 together. It may also have the function of protecting the stiffening members against mechanical damage.

In the embodiment illustrated in FIG. 12, the ladder comprises a stiffening structure 28. This may consist of stiffening ropes 29, a net or any other similar element placed between the two rails 11. This stiffening structure 28 makes it possible to secure the rails 11 together and prevents certain deformations of these rails. The elements forming this stiffening structure 28 can be fixed to hooks 30 or elements such as eyelets, provided for this purpose on the rails, for example on the stiffening members or on the envelope of the rails.

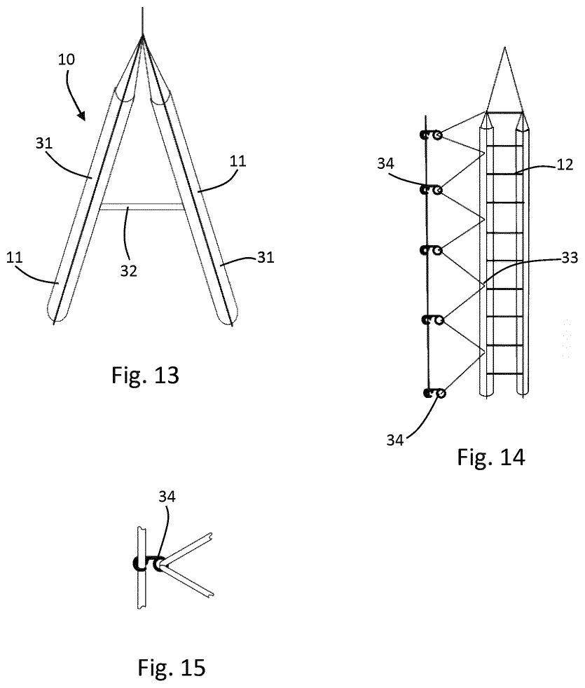

FIG. 13 is a profile view of a particular embodiment in which the ladder 10 has four rails 11. These rails are parallel in pairs and the top ends of two non-parallel rails meet. The ladder is thus made up of two sections 31, the ends of which are joined together. The rungs of the two sections are substantially parallel to each other. Rungs linked to two separate sections of the ladder may be connected by one or more rigid bars 32 so as to prevent the rails from bending when a user climbs onto one of the sections 31 of the ladder.

It is also possible to provide a structure or ladder comprising three or four rails parallel to each other and therefore not meeting at the top. These rails can be connected to each other by rungs, the structure then delimiting an enclosed space improving the safety of the user. The number of rails can be varied according to the final shape desired for the ladder and the shape and/or size of the enclosed space defined by the rungs connecting adjacent rails in pairs.

FIGS. 14 and 15 illustrate an embodiment of the ladder according to the present invention in which fasteners 33 can be fitted in places other than just at the top of the ladder. These fasteners can be placed on the rungs 12 or the rails 11 and enable the ladder to be connected to a support by means of hooks 34.

This embodiment is advantageous for several reasons. On the one hand, the intermediate fasteners 33 make it possible to secure the ladder and prevent excessive deformation or dynamic deformation of the ladder. On the other hand, the fasteners 33 prevent the ladder from slipping or moving during use, particularly when it is being used on a moving support such as a boat. The fasteners also allow the ladder to be used before it is fixed at the top. In fact, it is possible to deploy the ladder without securing it at the top, and then to secure it at regular intervals, starting at the bottom and then gradually climbing towards the top. In this way, the ladder can be used even when the top fixing is not initially provided or when this top fixing is not accessible from below. In this way, the ladder has the same advantages as a ladder with rigid rails.

Various features of the invention have been described in relation to different embodiments. These features may be applied in embodiments other than those for which they have been specifically described. By way of example, structural ligaments have been mentioned in relation to certain embodiments only. These structural ligaments could be used in any of the embodiments described.

1. A ladder comprising:
at least one rail; and
a plurality of rungs integral with said at least one rail,
wherein the at least one rail comprises at least two stiffening members arranged to receive a filler material, the at least one rail being rigid when the stiffening members contain said filler material, and the at least one rail being flexible when the stiffening members do not contain said filler material.

2. The ladder of claim 1, wherein said filler material is a fluid.

3. The ladder of claim 1, wherein said filler material is selected from air, water and granular material.

4. The ladder of claim 1, wherein the at least one rail comprises a member for fixing the rungs.

5. The ladder of claim 4, wherein the member for fixing the rungs is selected from the group consisting of a rope, a strap, a cable, a chain and an envelope surrounding the at least one stiffening member.

6. The ladder of claim 4, wherein the rungs are integral with the member for fixing the rungs.

7. The ladder of claim 1, wherein the at least two stiffening members comprise structural reinforcing ligaments.

8. The ladder of claim 1, wherein said stiffening members of a same rail are joined together by a consolidation structure.

9. The ladder of claim 8, wherein the consolidation structure comprises at least one rope holding the stiffening members together.

10. The ladder of claim 1, wherein the at least one rail comprises an envelope surrounding the at least two stiffening members.

11. The ladder of claim 1, wherein the ladder comprises at least two rails, and a stiffening structure arranged to connect the rails together.

12. The ladder of claim 1, wherein the at least two stiffening members comprise a device for filler the filler material.

13. The ladder of claim 1, wherein stiffening members of a same rail comprise at least one reinforcement zone designed to prevent the formation of pockets of filler material when the latter is removed from the stiffening members.

14. The ladder of claim 1, wherein at least one stiffening members of a rail comprises at least one tube disposed inside of the at least one stiffening member.

15. The ladder of claim 1, wherein the ladder comprises at least three rails, two adjacent rails being connected together by rungs.

16. The ladder of claim 2, wherein said filler material is selected from the group consisting of air, water and granular material.
